(19) United States
(12) Patent Application Publication
(10) Pub. No.: US 2005/0202122 A1
(43) Pub. Date: Sep. 15, 2005

(54) Food material including much gamma-aminobutyric acid and method of manufacturing the same

(76) Inventors: Noriyoshi Ichijo, Nagano-shi (JP); Takeshi Nakazawa, Nagano-shi (JP); Hirokuni Kitajima, Nagano-shi (JP); Chie Aizawa, Nagano-shi (JP)

Correspondence Address: BIRCH STEWART KOLASCH & BIRCH, PO BOX 747, FALLS CHURCH, VA, 22040-0747, US

(21) Appl. No.: 10/795,421

(22) Filed: Mar. 9, 2004

(51) Int. Cl. A23K 1/00

(52) U.S. Cl. 426/52

(57) ABSTRACT

The method of the present invention is capable of manufacturing a food material, which is made from soybeans including much γ-aminobutyric acid and which can be widely used. The method of manufacturing a food material including much γ-aminobutyric acid comprises a step of incubating lactic acid bacteria having glutamic acid decarboxylase in a medium, which is made from steamed soybeans including glutamic acid or salt of glutamic acid.

### BACKGROUND OF THE INVENTION

The present invention relates to a food material including much γ-aminobutyric acid (GABA) and a method of manufacturing the food material.

GABA, which is neurotransmitters, are widely existing not only in bodies but also in the natural world. They are effective for bring down blood pressure, tranquilization, preventing fatness, etc. Further, GABA has no side effects, so it is safe even if we eat it much. GABA has been added to food materials to prevent lifestyle-related diseases, especially high blood pressure. For example, “Gyabaron tea” is effective for preventing high blood pressure.

However, amounts of GABA included in the food materials are small. Thus, we must have a large amount of the food materials so as to get the effects of GABA. Namely, it is difficult to easily take a large amount of GABA every day.

Conventional food materials including GABA are disclosed in Japanese Patent Gazette No. 2000-210075 and No. 2001-352940. In the case of adding the food materials to seasonings, e.g., miso (processed soybean paste), soy sauce, a large amount of the food materials must be added to the seasonings. However, amounts of the seasonings to be used are small because their concentration of salt are high. Therefore, flavor of the seasonings will be badly influenced by a large amount of the food materials including GABA.

A method of enriching GABA in soybeans is disclosed in Japanese Patent Gazette No. 2002-45138. The soybeans are treated with protease when they are dipped. However, the soybeans are good for tofu (soybean curd) and soybean milk, but an amount of GABA included in the soybeans is small to use as food materials for enriching GABA.

### SUMMARY OF THE INVENTION

The invention has been invented to solve the disadvantages of the conventional food materials including GABA.

An object of the present invention is to provided a method of manufacturing a food material, which is made from soybeans including much γ-aminobutyric acid and which can be widely used.

Another object of the present invention is to provide a food material, which is made from soybeans including much γ-aminobutyric acid and which can be easily taken.

To achieve the objects, the inventors paid attention to lactic acid bacteria having glutamic acid decarboxylase, so they reached the present invention, in which lactic acid bacteria are grown at a medium, which is made from steamed soybeans including glutamic acid or salt of glutamic acid. Further, they studied to improve productivity of GABA, then they found that the GABA productivity of lactic acid bacteria was increased by reducing a pH value of soybeans with acid. Further, they found that the GABA productivity was highly increased by incubating lactic acid bacteria in the medium, which is made from steamed soybeans, under an anaerobic condition.

By incubating lactic acid bacteria having glutamic acid decarboxylase in the medium made from the soybeans, food materials including much GABA can be manufactured. Further, foods including much GABA, e.g., miso, soybean milk, can be made from the food materials.

Many kinds of foods are made from soybeans, and we eat them every day. The foods made from soybeans are recognized as healthy foods, so we can easily take much GABA with the foods made from soybeans.

The method of manufacturing a food material including much γ-aminobutyric acid of the present invention comprises a step of:

incubating lactic acid bacteria having glutamic acid decarboxylase in a medium, which is made from steamed soybeans including glutamic acid or salt of glutamic acid.

In the method, the soybeans may include acid.

In the method, a preferable pH value of the soybeans is 4.5-6.0.

In the method, the incubating step may be executed, under an anaerobic condition, in an air-tightly closed vessel.

The food material of the present invention is manufactured by said method.

The food material may be manufactured by processing the food material with executing at least one treatment selected from heating, drying, powderization, homogenizing, filtering, centrifugal separation and condensation.

Beverage, seasonings and foods of the present invention are manufactured with the food material.

In the present invention, lactic acid bacteria having glutamic acid decarboxylase are grown at the medium made from steamed soybeans including glutamic acid or salt of glutamic acid, so that much GABA can be added to the soybeans. The soybeans including much GABA can be used as the food material of foods including much GABA. Consumers can easily take much GABA. The beverages, seasonings and foods including much GABA are effective for blood pressure, so they can contribute to human health.

### DETAILED DESCRIPTION OF THE EMBODIMENTS

Preferred embodiments of the present invention will now be described in detail.

In the present invention, lactic acid bacteria having glutamic acid decarboxylase must be normally grown at soybeans, but product districts and species of soybeans are not limited.

In the present invention, steamed soybeans are used as a medium of lactic acid bacteria. As far as soybeans are not processed in an aseptic processing line, the eutrophic medium becomes sticky by contaminant when the incubation is completed. In the sticky medium, growth of lactic acid bacteria is worse, glutamic acid which is a precursor of GABA is assimilated by contaminant and a bad smell is given off, so that productivity of GABA can be lowered. The problems are caused by sporeforming bacteria, so breeding of the bacteria must be prevented.

To prevent sporeforming bacteria from incubating, an organic acid is added in a water, in which soybeans are soaked. The organic acid is harmless to human bodies, it is not volatilized by steaming soybeans, and it sterilizes sporeforming bacteria. Since the soybeans include the organic acid, growth of sporeforming bacteria can be prevented. Acetic acid, lactic acid, citric acid, etc. may be used as the organic acid. A preferable organic acid is lactic acid, which has no bad smell and well matches with foods and which can be treated easily. Concentration of lactic acid in the water is adjusted so as to actively grow lactic acid bacteria and well prevent growth of sporeforming bacteria. Preferable concentration of lactic acid is 0.5-1.5 wt %.

In the present invention, lactic acid is added to soybeans to prevent growth of unwanted bacteria. Further, the lactic acid bacteria having glutamic acid decarboxylase improve productivity of GABA. By adding lactic acid to soybeans, a pH value of the soybeans is lowered, so that the productivity of GABA can be highly improved. The productivity of GABA can be improved by other organic acids and inorganic acids, e.g., hydrochloric acid. However, as described above, organic acids are proper for prevention of sporeforming bacteria. To add the acid to soybeans, the acid is added to the water, further the acid may be added to steamed or boiled soybeans. A pH value of ordinary steamed or boiled soybeans is about 6.5. Preferably, the pH value is adjusted to 4.5-6.0 by adding the acid.

The soybeans may be steamed and boiled. But, in the present invention, the soybeans are steamed. If soybeans are boiled, nutrients solve out in water, so that growth of lactic acid bacteria is worse and the productivity of GABA must be lower.

In the present invention, lactic acid bacteria must have glutamic acid decarboxylase, but species of lactic acid bacteria are not limited. For example, IFO 3345 and IFO12005 of Lactobacillus brevis, Lactobacillus plantarum, Lactobacillus casei and Lactobacillus hilgardii produce GABA (see Japanese Patent Gazette No. 2002-101816).

Lactic acid bacteria having glutamic acid decarboxylase and producing GABA are isolated from fermented foods, plants, e.g., vegetables, soils, etc., and they are screened on the basis of their GABA productivity.

A preferable amount of inoculating lactic acid bacteria is 10⁵-10⁸ cells per 1 g of steamed soybeans. The GABA productivity is increased with increasing the amount of inoculating. Further, by increasing the amount of inoculating, lactic acid bacteria actively work from the beginning of the incubation, so that growth of unwanted bacteria can be effectively restricted.

An incubation time for changing glutamic acid or salt of glutamic acid to GABA is not limited, but a preferable time is two days or more.

A preferable growth temperature is 25-37° C. Further, GABA can be efficiently produced within 30-35° C.

An amount of glutamic acid or salt of glutamic acid with respect to that of the steamed soybeans is not limited. A preferable amount is 0.1-6 wt %.

A method of manufacturing the food material including much GABA will be explained. Firstly, a proper lactic acid bacterium is selected as described above. For example, a plurality of species of lactic acid bacteria are respectively incubated in MRS medium at 30° C. for several days. Then, amounts of glutamic acid and GABA of each culture are measured by an analyzer, e.g., L-8500 manufactured by Hitachi. The proper lactic acid bacterium is selected on the basis of the results. The selected lactic acid bacteria are mixed with the steamed soybeans including glutamic acid or salt of glutamic acid and incubated at 30° C. for two days or more. After the incubation, soybeans including much GABA, which is changed by glutamic acid decarboxylase of the lactic acid bacteria, can be made.

If the incubation is executed, under an anaerobic condition, in, for example, an air-tightly closed vessel, the GABA productivity can be highly improved. The anaerobic condition can be produced by, for example, sucking and removing air from the incubation vessel and filling the same with nitrogen, carbon dioxide gas, etc.

If the soybeans including much GABA is used for miso and soy sauce, which has high salt concentration, much GABA can be taken from a small amount of miso and soy sauce. Therefore, health seasonings for people whose blood pressure are high can be provided. The food material including much GABA can be used as a part of materials of soybean milk, tofu, etc. without badly influencing flavor.

The food material including much GABA may be formed into dry powders. The powders can be used with other foods and food materials and provided as supplements. Therefore, GABA can be taken easily.

In the case of using the food material as a material of miso or soy sauce, the salt concentration of miso or soy sauce is high, so microbes die during an aging process. Therefore, a sterilizing step, e.g., heating, can be omitted. In the case of using the food material as a material of soybean milk or tofu too, microbes die during a heating step. Namely, the food material can be used without sterilizing. Since microbes, e.g., lactic acid bacteria, die during the process of manufacturing the foods, flavor of the foods are not badly influenced by microbes.

In the case of using the food material for other foods, the food material may be formed into dry powders, paste, water soluble form, etc. They may be formed by heating, drying, powderization, homogenizing, filtering, centrifugal separation or condensation. By drying the soybeans including much GABA, concentration of GABA is made double. Further, a food material, in which GABA is highly concentrated, may be manufactured by the steps of: adding water to the soybeans including much GABA; homogenizing the soybeans; filtering or centrifugal-separating insoluble residue; and drying water soluble components. The food material, in which GABA is highly concentrated, may be used as a material of the foods.

An example of the method of manufacturing the food material will be explained. Note that, the present invention is not limited to the following example.

### Selecting Lactic Acid Bacteria

Firstly, a plurality of lactic acid bacteria were isolated from vegetables and fermented foods. Prescribed amounts of the lactic acid bacteria were respectively inoculated in MRS medium (made by Difco), which include 1% of sodium glutamate (MSG), and incubated at 30° C. for three days. Amounts of free glutamic acid and GABA in each culture were measured by the analyzer (L-8500 manufactured by Hitachi). The results are shown in TABLE 1.

TABLE 1

| | GLUTAMIC ACID | GABA | |
|---|---|---|---|
| NO. | mg % | mg % | LACTIC ACID BACTERIA |
| 1 | 0 | 610 | Enterococcus avium |
| 2 | 8 | 507 | Enterococcus avium |
| 3 | 3 | 517 | Enterococcus avium |
| 4 | 261 | 280 | Enterococcus gallinarum |
| 5 | 0 | 450 | Enterococcus avium |
| 6 | 24 | 450 | Lactobacillus brevis |
| 7 | 0 | 449 | Lactobacillus brevis |
| 8 | 36 | 231 | Lactobacillus brevis |
| 9 | 42 | 386 | Lactobacillus brevis |
| 10 | 52 | 404 | Lactobacillus brevis |

### Manufacturing Soybeans Including Much GABA

Next, the lactic acid bacteria, which were capable of producing GABA, were grown at steamed soybeans.

Soybeans were soaked in water, which includes 1 wt % of lactic acid, for one night, then water was drained. The soybeans were steamed. A pH value of the steamed soybeans was about 5.2. The steamed soybeans were cooled until about 30° C., then MSG, whose amount was 5 wt % of the steamed soybeans, and 1 wt % of each culture, in which the lactic acid bacteria were incubated to 10⁹ cells/ml, were mixed with the steamed soybeans. The lactic acid bacteria were grown under aerobic conditions. For example, they were incubated at a culture dish, which cannot be air-tightly closed but can prevent invasion of unwanted bacteria, at 30° C. for two days.

Further, the lactic acid bacteria were grown under anaerobic conditions. For example, the lactic acid bacteria were accommodated in vessels, which can be air-tightly closed. Air in the vessels were sucked and removed, then carbon dioxide gas was introduced into the vessels. The lactic acid bacteria were grown at 30° C. for two days. In this stage, lactic acid bacteria No. 1, 2, 3 and 7 of TABLE 1, which were capable of efficiently changing glutamic acid to GABA, were selected. Then, GABA was produced with the selected lactic acid bacteria No. 1, 2, 3 and 7 and the known lactic acid bacteria Lactobacillus brevis IFO3345 and IFO12005. Free glutamic acid and GABA were measured by the same manner. The results are shown in TABLE 2.

TABLE 2

| | AEROBIC CONDITION | | ANAEROBIC CONDITION | |
|---|---|---|---|---|
| | GLUTAMIC ACID | GABA | GLUTAMIC ACID | GABA |
| | (mg %) | (mg %) | (mg %) | (mg %) |
| No. 1 | 2218 | 1021 | 413 | 2095 |
| No. 2 | 2216 | 1101 | 535 | 2097 |
| No. 3 | 2288 | 972 | 531 | 2043 |
| No. 7 | 3832 | 406 | 716 | 1817 |
| IFO3345 | 3355 | 32 | 3211 | 259 |
| IFO12005 | 3544 | 35 | 2419 | 855 |

According to TABLE 2, all of the lactic acid bacteria can produce GABA in the aerobic condition. Further, glutamic acid can be efficiently changed to GABA in the anaerobic conditions.

### Manufacturing Miso Including Much GABA

A method of manufacturing rice-based miso with the soybeans including much GABA will be explained. The method may be applied to not only rice-based miso but also wheat-based miso, bean-based miso, etc.

Ordinary miso is made of steamed or boiled soybeans, rice koji and salt. In the present example, an amount of the steamed soybeans, which included 2 wt % of GABA, was 5 wt % of total weight of the miso. Namely, if the miso, which rice weight was 70 wt % of soybean, the salt was 12% and water was 45% was made, so 6.9 kg of ordinary steamed soybeans, 2.7 kg of the rice koji, 1.6 kg of the regular salt, 1.3 kg of water, 13 ml of yeast culture (5×10⁸ cells/ml) and 0.7 kg of the steamed soybeans including much GABA were prepared.

Firstly, the rice koji and the regular salt were mixed, then the ordinary steamed soybeans, the steamed soybeans including much GABA, the water, the yeast culture were mixed with the salted rice koji. Further, the mixture was fully agitated by a chopper. Then, the mixture was accommodated in a bucket without space, the bucket was covered with a cover, and the cover was pressed by a weight. The mixture was aged in an incubator at 30° C. for two months.

Free glutamic acid and GABA of the aged miso of the present example and those of ordinary miso were measured. The results are shown in TABLE 3.

TABLE 3

| | GLUTAMIC ACID | GABA |
|---|---|---|
| | (mg %) | (mg %) |
| MISO OF EXAMPLE | 484 | 178 |
| ORDINARY MISO | 440 | 49 |

According to TABLE 3, GABA in the miso of the present example were stable without decomposing throughout the manufacturing process including the aging step. By using the soybeans including much GABA, an amount of GABA in the miso could be greater than that in the ordinary miso. Flavor of the miso of the example was the same to that of the ordinary miso.

GABA helps to discharge sodium ions to urine. Therefore, salt can be effectively discharged from human bodies, and blood pressure can be brought down. Namely, we can eat the miso of the present example without paying attention to amount of salt.

### Manufacturing Soybean Milk, etc. Including Much GABA

A method of manufacturing soybean milk with the soybeans including much GABA will be explained.

In the present example, the steamed soybeans including 2 wt % of GABA were used as a part of raw soybeans. Rests were ordinary raw soybeans. 1 weight part of soybeans were washed and water was drained, then they were soaked in 2-3 weight part of water until they fully absorb the water. Water was drained. 0.9 weight part of the soaked soybeans, 0.1 weight part of the soybeans including much GABA were crushed and mixed with 3 weight part of water by a mixer. The mixture was heated by an open fire at 90° C. or more for 7-8 minutes. The mixture was squeezed to separate the soybean milk.

Next, a method of manufacturing tofu with the soybean milk will be explained.

0.0075 weight part of solidifying powder was added to 1 weight part of the soybean milk, then the soybean milk was accommodated in a mold, and water was removed. The soybean milk solidified and formed into tofu.

Free glutamic acid and GABA of the soybean milk and the tofu of the examples and those of ordinary soybean milk and tofu were measured. The results are shown in TABLE 4.

### Table 4

TABLE 4

| | SOYBEAN MILK | | TOFU | |
|---|---|---|---|---|
| | GLUTAMIC | | GLUTAMIC | |
| | ACID | GABA | ACID | GABA |
| | (mg %) | (mg %) | (mg %) | (mg %) |
| EXAMPLES | 5 | 27 | 5 | 27 |
| ORDINARY | 9 | 3 | 9 | 2 |
| SOYBEAN | | | | |
| MILK AND | | | | |
| TOFU | | | | |

According to TABLE 4, amounts of GABA in the soybean milk and tofu of the examples were greater than those in the ordinary soybean milk and tofu. The soybean milk and tofu of the examples was sweet and had no grassy smell of soybeans, so they could be easily eaten.

If the tofu including much GABA is used as ingredient of miso soup, which is made from the miso including much GABA, we can easily take much GABA. As described above, many foods, seasonings and beverages, e.g., tofu, soybean flour, tofu refuse, soy sauce, soybean milk, are made from soybeans. Therefore, if the foods, seasonings and beverages are made from the soybeans including much GABA, a large amount of GABA can be taken easily.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A method of manufacturing a food material including much γ-aminobutyric acid,
comprising a step of:
incubating lactic acid bacteria having glutamic acid decarboxylase in a medium, which is made from steamed soybeans including glutamic acid or salt of glutamic acid.

2. The method according to claim 1,
wherein the soybeans includes acid.

3. The method according to claim 2,
wherein a pH value of the soybeans is 4.5-6.0.

4. The method according to claim 1,
wherein said incubating step is executed, under an anaerobic condition, in an air-tightly closed vessel.

5. The method according to claim 2,
wherein said incubating step is executed, under an anaerobic condition, in an air-tightly closed vessel.

6. The method according to claim 3,
wherein said incubating step is executed, under an anaerobic condition, in an air-tightly closed vessel.

7. A food material manufactured by the method of claim 1.

8. A food material manufactured by the method of claim 2.

9. A food material manufactured by the method of claim 3.

10. A food material manufactured by the method of claim 4.

11. A food material manufactured by the method of claim 5.

12. A food material manufactured by the method of claim 6.

13. A food material manufactured by processing the food material of claim 7 with executing at least one treatment selected from heating, drying, powderization, homogenizing, filtering, centrifugal separation and condensation.

14. A food material manufactured by processing the food material of claim 8 with executing at least one treatment selected from heating, drying, powderization, homogenizing, filtering, centrifugal separation and condensation.

15. A food material manufactured by processing the food material of claim 9 with executing at least one treatment selected from heating, drying, powderization, homogenizing, filtering, centrifugal separation and condensation.

16. A food material manufactured by processing the food material of claim 10 with executing at least one treatment selected from heating, drying, powderization, homogenizing, filtering, centrifugal separation and condensation.

17. A food material manufactured by processing the food material of claim 11 with executing at least one treatment selected from heating, drying, powderization, homogenizing, filtering, centrifugal separation and condensation.

18. A food material manufactured by processing the food material of claim 12 with executing at least one treatment selected from heating, drying, powderization, homogenizing, filtering, centrifugal separation and condensation.

19. A beverage, seasoning or food manufactured with the food material of claim 7.

20. A beverage, seasoning or food manufactured with the food material of claim 13.
